(19) United States
(12) Patent Application Publication
(10) Pub. No.: US 2026/0064331 A1
(43) Pub. Date: Mar. 5, 2026

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: TAKASHI YABE, Chiba (JP)

(21) Appl. No.: 19/301,056

(22) Filed: Aug. 15, 2025

(30) Foreign Application Priority Data
Aug. 30, 2024 (JP) 2024-150230

(51) Int. Cl. G06F 3/12; G03G 15/00

(52) U.S. Cl. CPC G06F 3/121; G03G 15/502; G03G 15/5062; G03G 15/55; G06F 3/1211; G06F 3/1259

(57) ABSTRACT

The present disclosure is directed to image forming apparatus comprising: one or more memory devices that store a set of instructions; and one or more processors that execute the set of instructions to: diagnose, based on a first reference, a first abnormality in an image formed on a sheet, and diagnose a second abnormality based on a second reference stricter than the first reference; and set whether or not to execute diagnosis of the second abnormality, wherein the second abnormality is set not to be diagnosed when the second reference is a reference by which the second abnormality cannot be detected by diagnosis.

### BACKGROUND

### Field of the Technology

The present disclosure relates to an image forming apparatus, a control method thereof, and a storage medium.

### DESCRIPTION OF THE RELATED ART

There is a known image forming apparatus that detects an abnormality from an image on which an image is formed and specifies a part that is a factor in the abnormality (factor part) from the detected abnormality. An image forming apparatus including a capturing unit can capture an image formed on a sheet output from the image forming apparatus, detect an abnormality included in the image, and specify the part that is the factor. According to such an image forming apparatus, in order to perform maintenance work before a failure of the image forming apparatus actually occurs, it is also possible to diagnose a precursor of an impermissible abnormality by strictly setting a detection level of the abnormality. In Japanese Patent Laid-Open No. 2021-164105, an image forming apparatus that repairs an abnormality when the abnormality is detected is proposed.

For example, when the detection level of the abnormality is set to be equivalent to the detection capability of the abnormality of the image forming apparatus, the detection level of the precursor of the abnormality is set to be stricter than the detection level of the abnormality, and therefore the precursor of the abnormality cannot be detected. For example, also when the detection level of the precursor of the abnormality is set to a level exceeding the detection capability of the abnormality of the image forming apparatus, the precursor of the abnormality cannot be detected. However, even in these cases, the processing for precursor diagnosis of the abnormality is executed. Hence, execution of the processing for precursor diagnosis of the abnormality is wasted.

### SUMMARY

The present disclosure enables realization of a novel mechanism that can efficiently execute precursor diagnosis of an abnormality when the abnormality of an image is detected in an image forming apparatus.

One aspect of the present disclosure provides an image forming apparatus comprising: one or more memory devices that store a set of instructions; and one or more processors that execute the set of instructions to: diagnose, based on a first reference, a first abnormality in an image formed on a sheet, and diagnose a second abnormality based on a second reference stricter than the first reference; and set whether or not to execute diagnosis of the second abnormality, wherein the second abnormality is set not to be diagnosed when the second reference is a reference by which the second abnormality cannot be detected by diagnosis.

Another aspect of the present disclosure provides a control method of an image forming apparatus, the control method comprising: diagnosing, based on a first reference, a first abnormality in an image formed on a sheet, and diagnosing a second abnormality based on a second reference stricter than the first reference; and setting whether or not to execute diagnosis of the second abnormality, wherein the second abnormality is set not to be diagnosed when the second reference is a reference by which the second abnormality cannot be detected by diagnosis.

Still another aspect of the present disclosure provides a non-transitory computer-readable storage medium storing a computer program for causing a computer to execute each process in a control method of an image forming apparatus, the control method comprising: diagnosing, based on a first reference, a first abnormality in an image formed on a sheet, and diagnosing a second abnormality based on a second reference stricter than the first reference; and setting whether or not to execute diagnosis of the second abnormality, wherein the second abnormality is set not to be diagnosed when the second reference is a reference by which the second abnormality cannot be detected by diagnosis.

Features of the present disclosure will become apparent from the following description of embodiments with reference to the attached drawings. The following description of embodiments are described by way of example.

### BRIEF DESCRIPTION OF THE DRAWINGS

FIG. 1 a schematic diagram of a print system according to one embodiment

FIG. 2 a cross-sectional view of an image forming apparatus according to one embodiment

FIG. 3 a functional block diagram of the print system according to one embodiment

FIG. 4 a display screen of the image forming apparatus according to one embodiment

FIG. 5 a display screen of the image forming apparatus according to one embodiment

FIG. 6 a flowchart of processing according to one embodiment

FIG. 7 an explanatory diagram of a detection size according to one embodiment

FIG. 8 a display screen of the image forming apparatus according to one embodiment

FIGS. 9A and 9B Display screens of the image forming apparatus according to one embodiment

FIGS. 10A and 10B Display screens of the image forming apparatus according to one embodiment

FIG. 11 a display screen of the image forming apparatus according to one embodiment

FIG. 12 an explanatory diagram of repair content according to one embodiment

FIG. 13 a flowchart of processing according to one embodiment

FIG. 14 an explanatory diagram of the detection size according to one embodiment

FIG. 15 a display screen of the image forming apparatus according to one embodiment

FIG. 16 a display screen of the image forming apparatus according to one embodiment

FIG. 17 a display screen of the image forming apparatus according to one embodiment

FIG. 18 a display screen of the image forming apparatus according to one embodiment

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present description, the term "image forming apparatus" widely includes an apparatus that forms (records) an image on a printing material (also called a recording medium, a sheet, or paper), such as a single function printer, a copying machine, a multifunction peripheral, and a commercial printer. ‎ Note that in the following image forming apparatus, the maximum size of the sheet that can be fed is the A3 longer side length in a conveyance direction and the A3 shorter side length in a direction perpendicular to the conveyance direction (hereinafter, also called an A3 machine). In the following, when an image is formed on a sheet, a case where the longer side of this sheet is arranged parallel to the conveyance direction of the sheet is called that the conveyance direction of the sheet is horizontal, and a case where the shorter side of the sheet is arranged parallel to the conveyance direction of the sheet is called that the conveyance direction of the sheet is vertical. Note that as the sheet, it is possible to use various sheet materials having different sizes and materials, such as paper such as plain paper or thick paper, a sheet material subjected to surface treatment such as coated paper, a plastic film, cloth, and a sheet material having a special shape such as an envelope or index paper.

### FIRST EMBODIMENT

### Configuration of Entire System

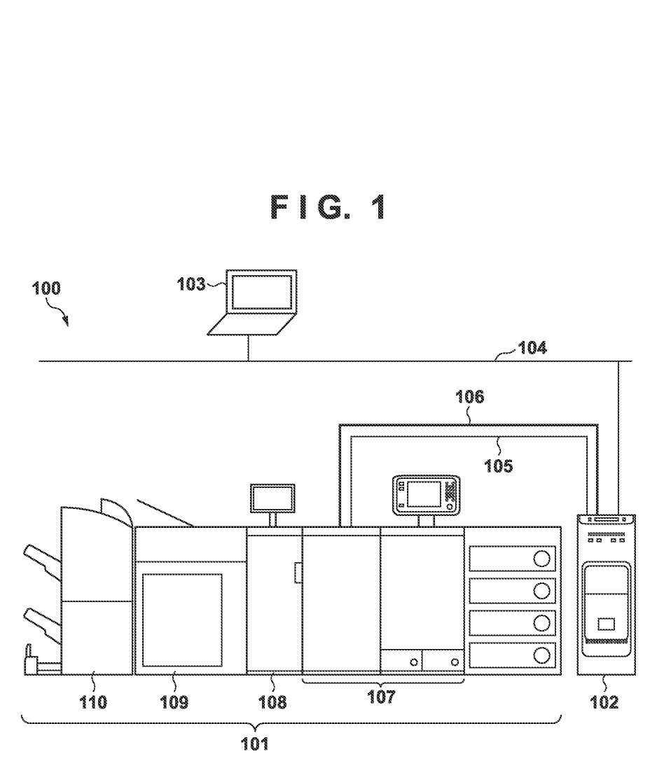

FIG. 1 is a view illustrating a network configuration example including a print system 100 (image processing system) according to the present embodiment. As illustrated in FIG. 1, the print system 100 includes an image forming apparatus 101 and an external controller 102. The image forming apparatus 101 and the external controller 102 are connected in a communication-enabling manner via an internal LAN 105 and a video cable 106. The external controller 102 is in a communication-enabling manner connected to a client PC 103 via an external LAN 104.

The client PC 103 can issue a print instruction to the external controller 102 via the external LAN 104. A printer driver having a function of converting image data that is a printing process target into a page description language (PDL) processable by the external controller 102 is installed in the client PC 103. By operating the client PC 103, a user who desires to perform print can issue a print instruction via the printer driver from various applications installed in the client PC 103. The printer driver transmits PDL data that is print data to the external controller 102 based on the print instruction from the user. Upon receiving the PDL data from the client PC 103, the external controller 102 performs analysis and interpretation of the received PDL data. Rasterizing processing is performed based on the result of the interpretation, a bitmap image (print image data) having a resolution matching the image forming apparatus 101 is generated, and a print job is submitted to the image forming apparatus 101, whereby the print instruction is issued.

Next, the image forming apparatus 101 will be described. The image forming apparatus 101 is configured such that a plurality of apparatuses having different functions are connected and complicated printing processing such as bookbinding is possible. That is, the image forming apparatus 101 includes a printing unit 107 (image forming unit), a diagnosis unit 108, a stacker 109, and a finisher 110. Each module will be described below. Note that the operation of the diagnosis unit 108 is an example of "diagnosing".

The printing unit 107 prints an image according to a print job, and discharges a printed printing material (sheet). The printed printing material discharged from the printing unit 107 is conveyed inside each apparatus in the order of the diagnosis unit 108, the stacker 109, and the finisher 110. In the present embodiment, the image forming apparatus 101 of the print system 100 is an example of an image forming apparatus, but the printing unit 107 included in the image forming apparatus 101 may be called an image forming apparatus. The printing unit 107 forms (prints) an image using a toner (color material) on a printing material to be fed and conveyed from a paper feed unit arranged in a lower part of the printing unit 107.

The diagnosis unit 108 is an image diagnosis apparatus that diagnoses presence or absence of an abnormal portion of the image forming apparatus 101 based on the printed printing material on which an image is printed by the printing unit 107, the printed printing material conveyed through a conveyance path. Specifically, the diagnosis unit 108 captures an image printed on the printed printing material having been conveyed, and implements diagnosis from the captured image having been obtained. The diagnosis of an abnormality is determined by extracting a diagnosis area from the captured image and confirming a captured signal value difference in the extracted diagnosis area. Detailed processing of the diagnosis unit will be described later. Note that the diagnosis unit is used also at the time of inspection. It is also an apparatus that inspects presence or absence of a failure of a printed printing material or an abnormality in the image quality based on comparison between print data and data of the printed printing material on which an image is printed by the printing unit 107 and conveyed through the conveyance path.

The stacker 109 is an apparatus that can stack a large number of printed printing materials. The finisher 110 is an apparatus that can execute finishing processing such as stapling processing, punching processing, and saddle stitch bookbinding processing on the printed printing material having been conveyed. The printing material processed by the finisher 110 is discharged to a predetermined paper discharge tray.

Note that in the configuration example of FIG. 1, the external controller 102 is connected to the image forming apparatus 101, but the present embodiment can also be applied to a configuration different from this. For example, a configuration may be used in which the image forming apparatus 101 is connected to the external LAN 104, and print data is transmitted from the client PC 103 to the image forming apparatus 101 without going through the external controller 102. In this case, data analysis and rasterization on the print data may be executed by the image forming apparatus 101.

### Hardware Configuration of Image Forming Appartus 101

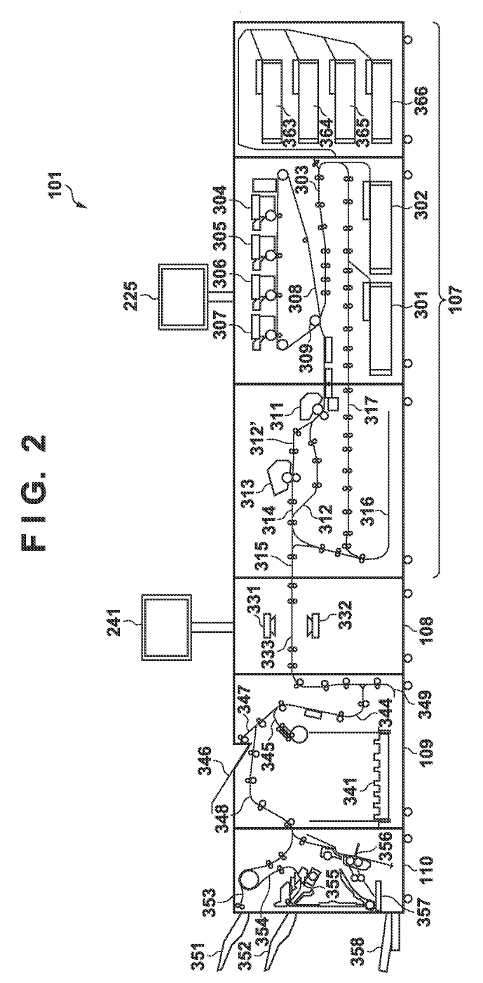

A specific operation example of the image forming apparatus 101 will be described with reference to FIG. 2.

### Description of Paper Feed Deck

The printing unit 107 includes, for example, six types of paper feed decks 361, 362, 363, 364, 365, and 366. Various printing materials are stored in each of the paper feed decks. Of the printing materials stored in each of the paper feed decks, the uppermost printing material is separated one by one and fed to a conveyance path 303. Image forming stations 304 to 307 each include a photosensitive drum (photoreceptor), and form a toner image on the photosensitive drum using toners of different colors. Specifically, the image forming stations 304 to 307 form toner images using toner of yellow (Y), magenta (M), cyan (C), and black (K), respectively.

The toner images of the respective colors formed by the image forming stations 304 to 307 are sequentially superimposed, and transferred to the intermediate transfer belt 308 (primary transfer). The toner image transferred to the intermediate transfer belt 308 is conveyed to a secondary transfer position 309, by the rotation of the intermediate transfer belt 308. At the secondary transfer position 309, the toner image is transferred from the intermediate transfer belt 308 to the printing material conveyed through the conveyance path 303 (secondary transfer). The printing material after the secondary transfer is conveyed to a fix unit 311. The fix unit 311 includes a pressurizing roller and a heating roller. Heat and pressure are applied to the printing material while the printing material passes between these rollers, whereby fix processing of fixing the toner image on the printing material is performed. The printing material having passed through the fix unit 311 is conveyed to a connection point 315 between the printing unit 107 and the diagnosis unit 108 through a conveyance path 312. In this manner, a color image is formed (printed) on the printing material.

When further fix processing is necessary depending on the type of the printing material, the printing material having passed through the fix unit 311 is guided to a conveyance path 314 provided with a fix unit 313. The fix unit 313 performs further fix processing on the printing material to be conveyed on the conveyance path 314. The printing material having passed through the fix unit 313 is conveyed to the connection point 315. When an operation mode for performing two-sided printing is set, an image is printed on a first surface, and the printing material conveyed on the conveyance path 312 or the conveyance path 314 is guided to a reverse path 316. The printing material reversed in the reverse path 316 is guided to a two-sided conveyance path 317 and conveyed to the secondary transfer position 309. By this, the toner image is transferred to a second surface on the side opposite to the first surface of the printing material at the secondary transfer position 309. Thereafter, the printing material passes through the fix unit 311 (and the fix unit 313), whereby the formation of the color image on the second surface of the printing material is completed.

The formation (printing) of the image at the printing unit 107 is completed, and the printed printing material conveyed to the connection point 315 is conveyed into the diagnosis unit 108. The diagnosis unit 108 includes image capturing units (331 and 332) having a contact image sensor (CIS) on a conveyance path 330 on which the printed printing material from the printing unit 107 is conveyed. The image capturing units (331 and 332) are arranged at positions facing each other via the conveyance path 330. The image capturing units (331 and 332) are configured to capture an upper surface (first surface) and a lower surface (second surface), respectively, of the printing material. Note that the image capturing unit may include, for example, a charge coupled device (CCD) or a line scan camera in place of the CIS.

The diagnosis unit 108 performs various types of image diagnosis processing of the image forming apparatus 101 based on the image printed on the printed printing material conveyed on the conveyance path 330. Specifically, the diagnosis unit 108 performs capturing processing of capturing the image of the printed printing material using the image capturing units (331 and 332) at a timing when the printed printing material during conveyance reaches a predetermined position. Then, using the captured image, for example, an inspection diagnosis for inspecting an abnormality (an example of the "first abnormality") of an output material during printing, and a precursor diagnosis for diagnosing a precursor of the abnormality (an example of the "second abnormality") are performed. In the present embodiment, the "abnormality (first abnormality)" indicates an abnormality with an impermissible quality level, and the "precursor (second abnormality)" indicates an abnormality at a previous stage that can become the first abnormality in the future. For these diagnoses, an image diagnosis technique is adopted. The diagnosis unit 108 specifies the precursor and a factor in the abnormality from the diagnosis result of the inspection diagnosis or the precursor diagnosis, and causes the printing unit 107 to execute processing of automatically repairing the factor part.

The precursor diagnosis is diagnosis in which a precursor considered to become an impermissible abnormality in the future is found and need not be repaired immediately after the diagnosis. The precursor diagnosis is basically performed with a print image being printed by the user. The image diagnosis is a diagnosis of finding an abnormality and immediately repairing the found abnormality. This is basically performed while printing is stopped. When the image diagnosis is performed by the image forming apparatus 101 alone, a chart for image diagnosis is printed, and the diagnosis is performed using the printed image. When an abnormality is found on a printed matter by inspection, the image diagnosis is also used when analyzing the factor in the abnormality.

The printing material having passed through the diagnosis unit 108 is sequentially conveyed to the stacker 109. The stacker 109 includes a stack tray 341. The printed printing material conveyed from the diagnosis unit 108 arranged upstream in the conveyance direction of the printed printing material is stacked on the stack tray 341. The printed printing material having passed through the diagnosis unit 108 passes through a conveyance path 344 in the stacker 109. The printed printing material passing through the conveyance path 344 is guided to a conveyance path 345, whereby the printed printing material is stacked on the stack tray 341.

The stacker 109 further includes an escape tray 346 as a paper discharge tray. In the present embodiment, the escape tray 346 is used to discharge a printing material in which a test chart used for image diagnosis by the diagnosis unit 108 is recorded. By being guided to a conveyance path 347, the printed printing material passing through the conveyance path 344 is conveyed to the escape tray 346. The printed printing material conveyed without being stacked and discharged in the stacker 109 is conveyed to the finisher 110 in the subsequent stage through a conveyance path 348. The escape tray 346 is also used to discharge a printed printing material determined to be a failure by inspection by the diagnosis unit 108.

The stacker 109 further includes a reversing unit 349 for reversing the orientation of the printed printing material to be conveyed. The reversing unit 349 is used, for example, to uniform the orientation of the printing material input to the stacker 109 and the orientation of the printed printing material when stacked on the stack tray 341 and output from the stacker 109. Note that the reversing operation by the reversing unit 349 is not performed on the printed printing material to be conveyed to the finisher 110 without being stacked on the stacker 109.

The finisher 110 executes a finishing function designated by the user on the printed printing material conveyed from the diagnosis unit 108 arranged upstream in the conveyance direction of the printed printing material. In the present embodiment, the finisher 110 has, for example, a finishing function such as a stapling function (one-place or two-place stitch), a punching function (two holes or three holes), and a saddle stitch bookbinding function. The finisher 110 includes two paper discharge trays 351 and 352. When the finishing processing by the finisher 110 is not performed, the printed printing material conveyed to the finisher 110 is discharged to the paper discharge tray 351 through a conveyance path 353. When finishing processing such as stapling processing is performed by the finisher 110, the printed printing material conveyed to the finisher 110 is guided to a conveyance path 354. Using a finishing processing unit 355, the finisher 110 executes the finishing processing designated by the user on the printed printing material to be conveyed on the conveyance path 354, and discharges, to the paper discharge tray 352, the printed printing material for which the finishing processing has been executed.

### Functional Configuration Diagram

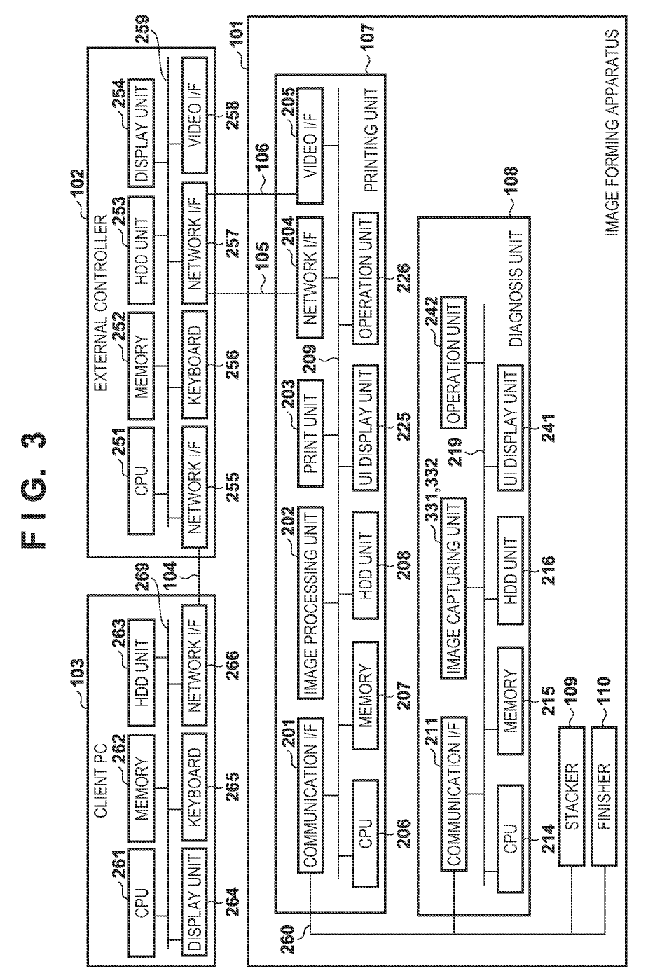

FIG. 3 is a schematic diagram of the functional block of the image forming apparatus 101, the external controller 102, and the client PC 103.

### Image Forming Apparatus 101

The printing unit 107 of the image forming apparatus 101 includes a communication interface (I/F) 201, a network I/F 204, a video I/F 205, a CPU 206, a memory 207, an HDD unit 208, a UI display unit 225, and an operation unit 226. The printing unit 107 further includes an image processing unit 202 and a print unit 203. These are connected to each other so as to be able to transmit and receive data to and from each other via a system bus 209. Note that the operation of the UI display unit 225 is an example of "displaying".

The communication I/F 201 is configured to include a communication module, and is connected to the diagnosis unit 108, the stacker 109, and the finisher 110 via a communication cable 260. The CPU 206 performs communication for controlling each apparatus via the communication I/F 201. The network I/F 204 is configured to include a communication module such as a network interface card (NIC), is connected to the external controller 102 via the internal LAN 105, and is used for communication of control data and the like. The video I/F 205 is configured to include a video module, is connected to the external controller 102 via the video cable 106, and is used for communication of data such as image data. Note that the printing unit 107 (image forming apparatus 101) and the external controller 102 may be connected only by the video cable 106 as long as the operation of the image forming apparatus 101 can be controlled by the external controller 102.

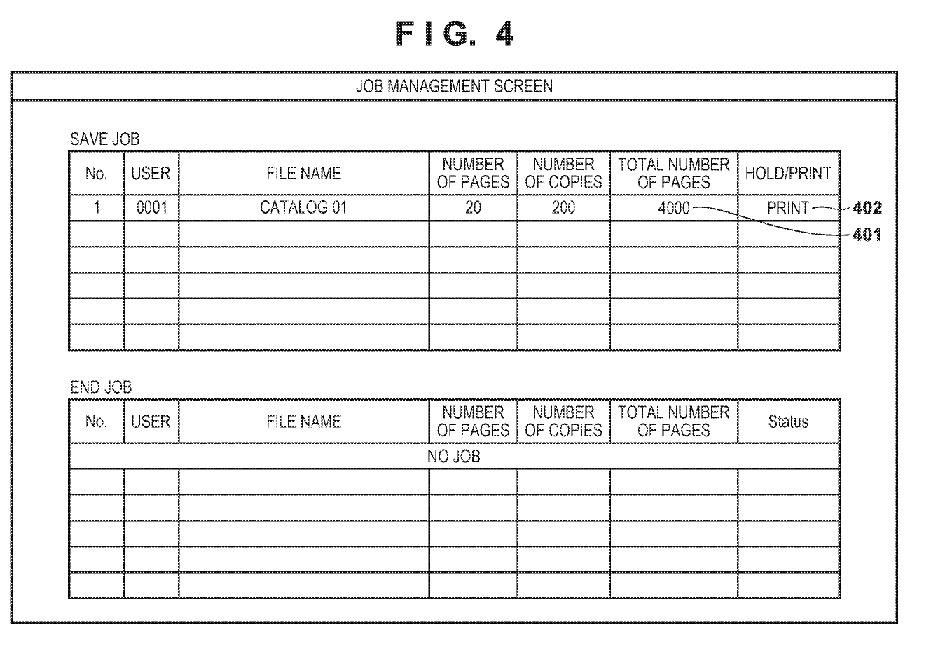

The HDD unit 208 saves various programs or data. The CPU 206 controls the entire operation of the printing unit 107 by executing a program saved in the HDD unit 208. The memory 207 stores programs and data required when the CPU 206 performs various types of processing. The memory 207 operates as a work area of the CPU 206. The UI display unit 225 is configured to include, for example, a touch panel display, receives an input of various settings and an instruction of an operation from the user, and is used to display print job management. For example, it is possible to perform display of the job management screen illustrated in FIG. 4, enabling the user to perform a touch operation, a slide operation, or the like for confirming or changing the print job. The operation unit 226 is configured to include, for example, this touch panel display and a button, and receives, for example, a setting change of the printing unit 107, a touch operation or a slide operation for instructing execution of various diagnoses, and the like.

The diagnosis unit 108 includes a communication I/F 211, a CPU 214, a memory 215, an HDD unit 216, image capturing units 331 and 332, a UI display unit 241, and an operation unit 242. These devices are connected to each other so as to be able to transmit and receive data to and from each other via the system bus 219. The communication I/F 211 is configured to include a communication module, and is connected to the printing unit 107 via the communication cable 260. The CPU 214 performs communication necessary for control of the diagnosis unit 108 via the communication I/F 211. The CPU 214 controls the operation of the diagnosis unit 108 by executing a control program stored in the memory 215. The control program for the diagnosis unit 108 is saved in the memory 215. The image capturing units (331 and 332) are configured to include, for example, a scanner, and capture an image in accordance with an instruction from the CPU 214. In the image diagnosis, the CPU 214 diagnoses the presence or absence of an abnormal portion of the image forming apparatus 101 based on a captured image for diagnosis captured by the image capturing units (331 and 332). In inspection in particular, the CPU 214 captures a printing material printed in the image forming apparatus 101 via the image capturing units (331 and 332), and inspects a failure (abnormality) of the printed printing material based on the captured image having been captured.

The UI display unit 241 is configured to include, for example, a touch panel display, and is used to display results of various diagnoses, an implementation status of automatic repair based on the diagnosis result, a setting screen, and the like. The operation unit 242 is configured to include this touch panel display, and receives, for example, a setting change of the diagnosis unit 108, a touch operation or a slide operation for instructing execution of various diagnoses, and the like.

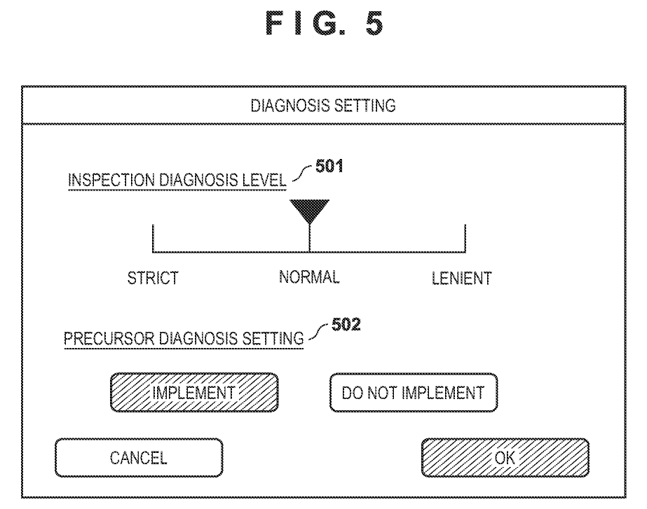

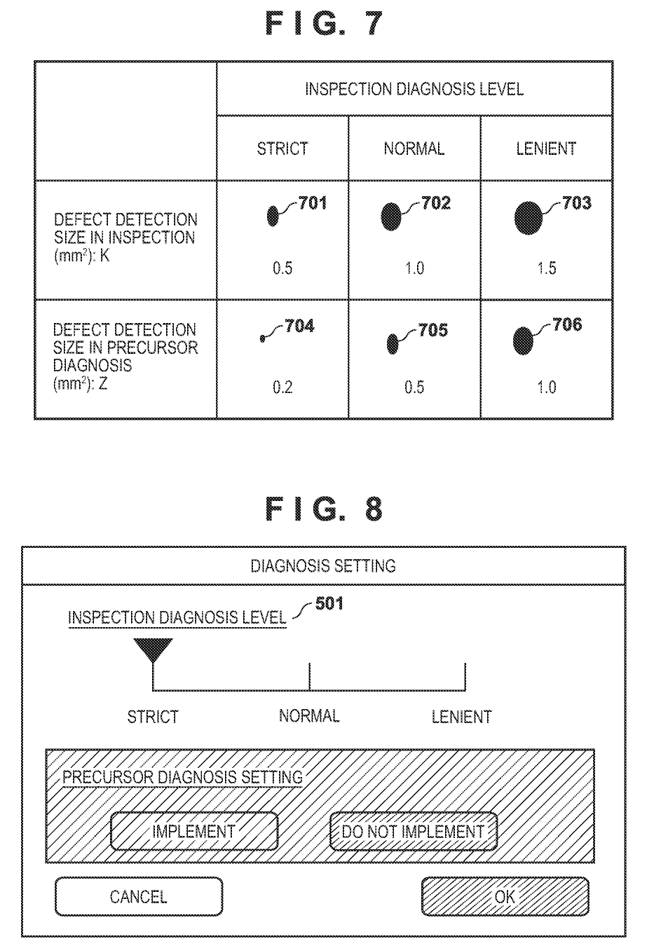

A diagnosis setting screen displayed on the UI display unit 241 of the diagnosis unit 108 will be described with reference to FIG. 5. On the diagnosis setting screen, an inspection diagnosis level 501 and a precursor diagnosis setting 502 can be set. In the example illustrated in FIG. 5, the inspection diagnosis level 501 is set to "normal", the precursor diagnosis setting 502 is set to "implement", and this setting is a default setting. As the inspection diagnosis level 501 changes stepwise from "strict", "normal", to "lenient", the size of the abnormality to be detected increases. Here, an example of the minimum size detectable at each level is the area illustrated in FIG. 7. Note that although "strict", "normal", and "lenient" are displayed as the inspection diagnosis level, these examples are merely examples, and the inspection diagnosis level is not limited to them. For example, a diagnosis level may be provided between "strict" and "normal", or between "normal" and "lenient", and the number of inspection diagnosis levels may be two, five, or whatever.

The HDD unit 216 saves setting information and image data necessary for various diagnoses. Various pieces of setting information and image data saved in the HDD unit 216 can be reused. The stacker 109 performs control of discharging the printed printing material having passed through the conveyance path to the stack tray, to the escape tray, or conveying it to the finisher 110 connected downstream in the conveyance direction of the printed printing material. The finisher 110 controls conveyance and discharge of the printed printing material, and performs finishing processing such as stapling, punching, or saddle stitch bookbinding.

### External Controller 102

The external controller 102 includes a CPU 251, a memory 252, an HDD unit 253, a keyboard 256, a display unit 254, network interfaces (255 and 257), and a video I/F 258. These devices are connected to each other so as to be able to transmit and receive data to and from each other via the system bus 259.

By executing a program saved in the HDD unit 253, the CPU 251 controls the entire operation of the external controller 102 such as, for example, reception of print data from the client PC 103, RIP processing, and transmission of print data to the image forming apparatus 101. The memory 252 stores programs and data required when the CPU 251 performs various types of processing. The memory 252 operates as a work area of the CPU 251.

The HDD unit 253 saves various programs and data. The keyboard 256 is used for inputting an operation instruction for the external controller 102 from the user. The display unit 254 is, for example, a display, and used for displaying information on an application being executed in the external controller 102 and an operation screen. The network I/F 255 is configured to include a communication module such as an NIC or a wireless circuit, is connected to the client PC 103 via the external LAN 104, and is used for data communication such as a print instruction. The network I/F 257 is configured to include a communication module such as an NIC, is connected to the image forming apparatus 101 via the internal LAN 105, and is used for data communication such as a print instruction. The external controller 102 is configured to be capable of communicating with the printing unit 107, the diagnosis unit 108, the stacker 109, and the finisher 110 via the internal LAN 105 and the communication cable 260. The video I/F 258 is configured to include a video module, is connected to the image forming apparatus 101 via the video cable 106, and is used for communication of data such as image data (print data).

### Client PC 103

The client PC 103 includes a CPU 261, a memory 262, an HDD unit 263, a display unit 264, a keyboard 265, and a network I/F 266. These devices are connected to each other so as to be able to transmit and receive data to and from each other via the system bus 269. By executing a program saved in the HDD unit 263, the CPU 261 controls the operation of each device via the system bus 269. Thus, various types of processing by the client PC 103 are implemented. For example, by executing a document processing program saved in the HDD unit 263, the CPU 261 generates print data and issues a print instruction. The memory 262 stores programs and data required when the CPU 261 performs various types of processing. The memory 262 operates as a work area of the CPU 261.

The HDD unit 263 saves, for example, various applications such as a document processing program, programs such as a printer driver, and various data. The display unit 264 is, for example, a display, and is used for displaying information on an application being executed in the client PC 103 and an operation screen. The keyboard 265 is used for inputting an operation instruction for the client PC 103 from the user. The network I/F 266 is configured to include a communication module such as an NIC or a wireless circuit, and is connected to the external controller 102 in a communication-enabling manner via the external LAN 104. The CPU 261 communicates with the external controller 102 via the network I/F 266.

### Inspection Diagnosis Processing and Precursor Diagnosis Processing

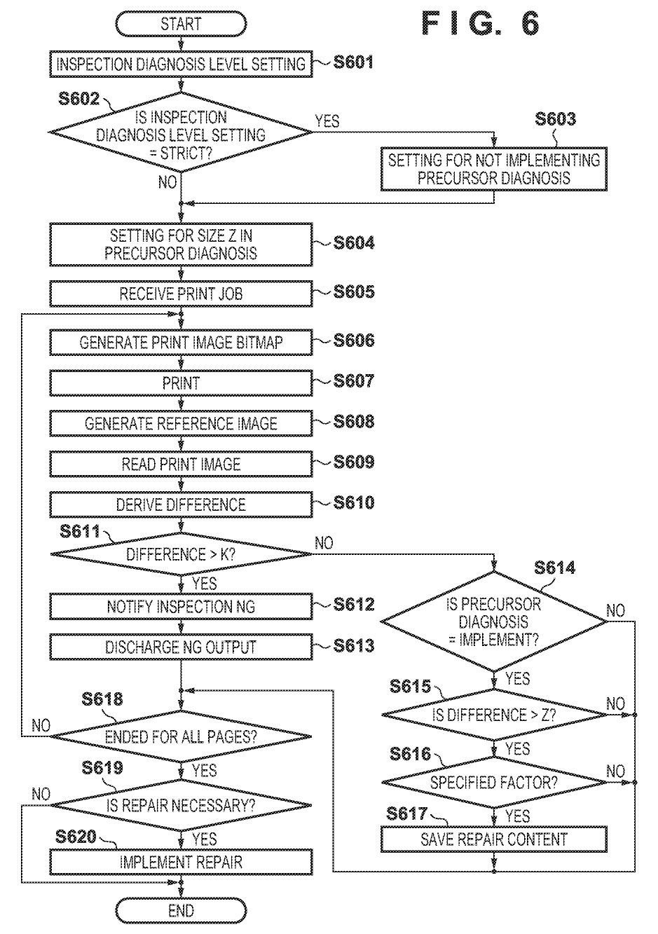

FIG. 6 is a flowchart showing a procedure of inspection diagnosis processing and precursor diagnosis processing performed at the time of printing, which are started by a print instruction of the printing unit 107. Note that the processing in FIG. 6 is implemented, for example, by the CPU 206 of the printing unit 107 and the CPU 214 of the diagnosis unit 108 of the image forming apparatus 101 reading and executing programs stored in the memory 207 and the memory 215. The processing in FIG. 6 is implemented, for example, by the CPU 251 of the external controller 102 reading and executing a program stored in the memory 252. The processing in FIG. 6 is implemented, for example, by the CPU 251 of the client PC 103 reading and executing a program stored in the memory 252. Note that before the start of the processing in FIG. 6, the precursor diagnosis is set to "implement".

In S601, the CPU 214 of the diagnosis unit 108 displays the diagnosis setting screen illustrated in FIG. 5 of the user mode on the UI display unit 241. Then, the CPU 214 receives a slide operation of an arrow of the inspection diagnosis level 501 via the operation unit 242. Then, the CPU 214 sets the level indicated by this arrow as the inspection diagnosis level. Then, the CPU 214 sets a detection size K of an abnormality in the inspection as illustrated in FIG. 7 according to the setting of the inspection diagnosis level, and performs setting as to what size of the abnormality to detect. For example, as illustrated in FIG. 5, when the inspection diagnosis level is set to "normal", the detection size K of the abnormality in the inspection is set to 1.0 mm². Details of the relationship between the inspection diagnosis level and the detection size area of the abnormality illustrated in FIG. 7 will be described later. Note that although the example in which the CPU 214 sets the detection size K from the UI setting of the user mode has been described here, the detection size K may be set from an administrator mode setting or a service mode setting.

In S602, the CPU 214 receives the slide operation of the arrow indicating the inspection diagnosis level 501 on the diagnosis setting screen (FIG. 5) in the user mode via the operation unit 242. Then, it is determined whether the inspection diagnosis level is set to "strict" according to the position of the arrow. When detecting that the arrow indicating the inspection diagnosis level is positioned at "strict", the CPU 214 determines that the inspection diagnosis level is set to "strict". Then, the CPU 214 sets the detection size K of the abnormality in the inspection to a limit size (0.5 mm²) that can be detected by the diagnosis unit 108, and proceeds to S603. On the other hand, when not detecting that the arrow indicating the inspection diagnosis level is positioned at "strict", the CPU 214 does not determine that the setting of the inspection diagnosis level is set to "strict", and proceeds to S604. Note that the CPU 214 determines whether or not the setting value of the detection size K is 0.5 mm² or less, and may proceed to S603 when the setting value is 0.5 mm² or less, and may proceed to S604 otherwise.

In S603, the CPU 214 sets the precursor diagnosis to "do not implement", and changes the color of the icon of "do not implement" of the setting of the precursor diagnosis as illustrated in FIG. 8 (an example of "identifiably display not diagnosing the second abnormality"). The area for the precursor diagnosis setting is grayed out (an example of "display the second setting such that it cannot be selected"). By doing this, it is displayed that the setting of the precursor diagnosis cannot be selected. Note that the operation of the CPU 214 in S603 is an example of "setting".

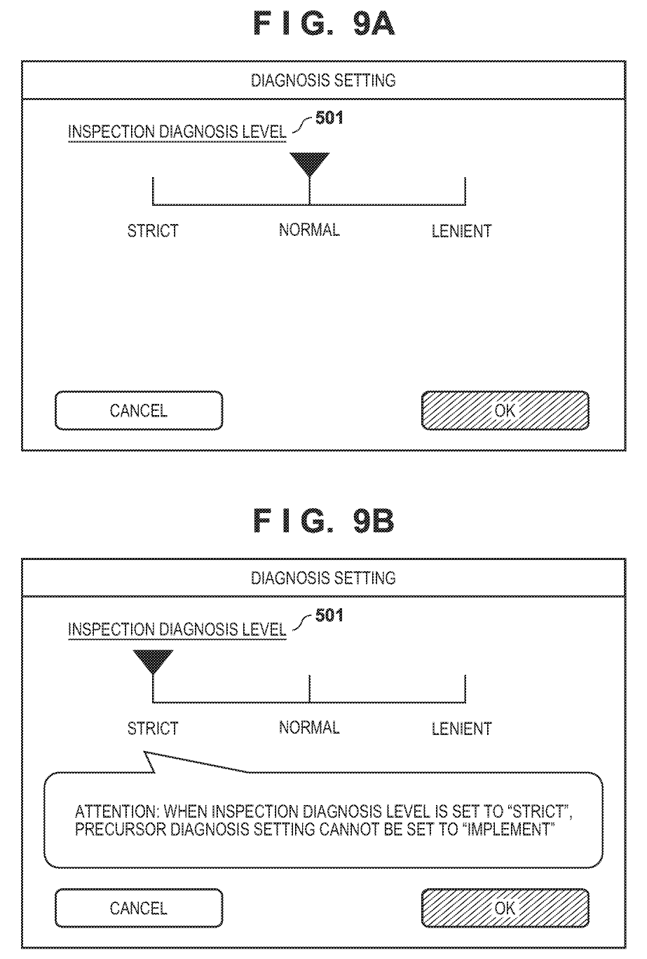

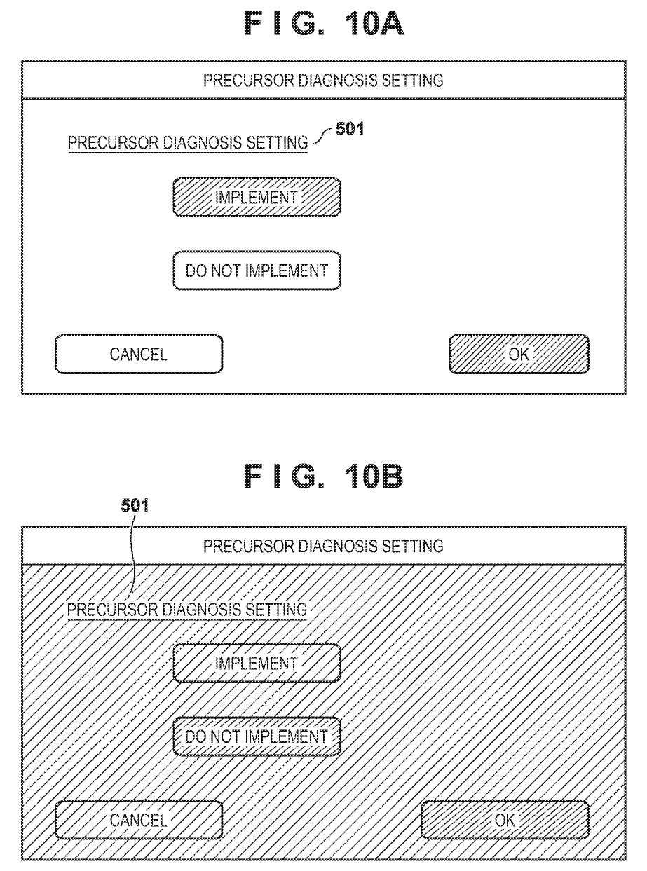

In the above example, the inspection diagnosis level and implementation of the precursor diagnosis can be set on the same diagnosis setting screen (FIGS. 5 and 8), but the inspection diagnosis level and implementation of the precursor diagnosis may be set on individual screens. FIGS. 9A and 9B illustrate a setting screen of the inspection diagnosis level, and FIGS. 10A and 10B illustrate a setting screen of implementation of the precursor diagnosis. Note that the setting screens illustrated in FIGS. 9A and 9B transition to the setting screens illustrated in FIGS. 10A or 10B when an OK icon is touched.

More specifically, FIG. 9A illustrates a case where the arrow icon indicating the inspection diagnosis level is positioned at "normal", and FIG. 9B illustrates a case where the arrow icon indicating the inspection diagnosis level is positioned at "strict". When the arrow icon indicating the inspection diagnosis level is positioned at "strict", the CPU 214 sets the precursor diagnosis to "do not implement". Then, the CPU 214 displays a pop-up including a message that the precursor diagnosis cannot be set to "implement" and calls attention to the user. Note that this message is an example of the "message indicating that diagnosis of the second abnormality cannot be performed when the first reference is set to a strictest reference of a plurality of references".

Then, the CPU 214 changes the color of the icon of "do not implement" on the setting screen illustrated in FIG. 10B. Then, the CPU 214 grays out the entire screen in order to indicate that the setting of the precursor diagnosis cannot be changed. On the other hand, when not detecting that the arrow icon indicating the inspection diagnosis level is positioned at "strict", the CPU 214 displays a setting screen on which either "implement" or "do not implement" the precursor diagnosis can be selected as illustrated in FIG. 10A. Then, the CPU 214 receives a setting input of the precursor diagnosis via the operation unit 226.

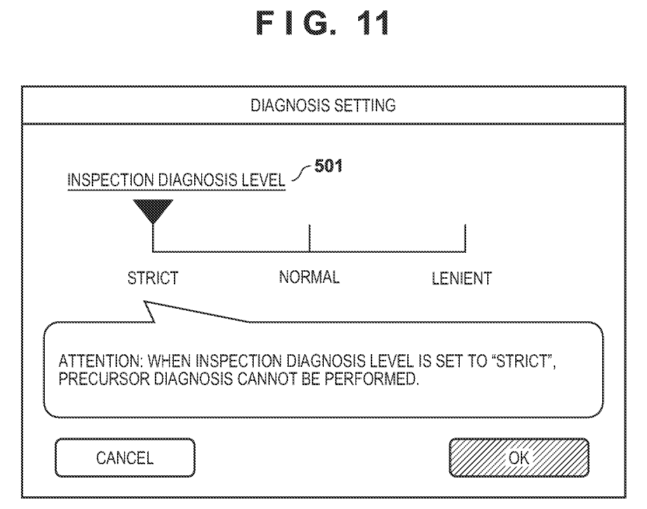

Alternatively, the user may select the inspection diagnosis level, and presence or absence of implementation of the precursor diagnosis may be automatically set according to the selection of the inspection diagnosis level. FIG. 11 illustrates a setting screen on which only the inspection diagnosis level is selectively displayed. When the arrow icon indicating the inspection diagnosis level is positioned at "strict", the CPU 214 automatically sets the precursor diagnosis to "do not implement". Then, the CPU 214 displays a pop-up including a message that the precursor diagnosis cannot be set to "implement" and calls attention to the user. On the other hand, when the arrow icon indicating the inspection diagnosis level is positioned at "normal" or "lenient", the CPU 214 automatically sets the precursor diagnosis to "implement". The screen described above is an example, and the setting screen may be any screen as long as the precursor diagnosis is set to "do not implement" when the inspection diagnosis level is set to "strict".

In S604, the abnormality detection size in the precursor diagnosis is set. More specifically, an abnormality detection size Z in the precursor diagnosis is set as illustrated in FIG. 7 according to the setting of the inspection diagnosis and the setting of the precursor diagnosis. More specifically, the abnormality detection size Z in the precursor diagnosis is set to a value smaller than the size K.

In S605, the CPU 206 of the printing unit 107 displays a job management screen as illustrated in FIG. 4 on the UI display unit 225. The user can input a print job by performing a touch operation on a print instruction 402 on the job management screen. Then, the CPU 206 receives this print job via the operation unit 226. Then, the CPU 206 transmits information on the print job to the external controller 102 via the network I/F 204.

In S606, the CPU 251 of the external controller 102 receives the print job information from the printing unit 107 via the network I/F 257. Then, the CPU 251 generates a bitmap for printing by rasterizing the page to be printed. In S607, the CPU 251 transmits the rasterized bitmap data to the video I/F 205 of the printing unit 107 via the video I/F 258 and the video cable 106. The CPU 206 of the printing unit 107 receives the bitmap data via the video I/F 205 to perform print.

In S608, the CPU 214 of the diagnosis unit 108 generates a reference image (an example of the "original image") in which the resolution and the like are changed so that the bitmap rasterized for printing can be compared in difference with the print image in which the printed matter in S610 is captured. Note that for example, the reference image may use, for example, a normally printed image, and may be a normally printed image with which a difference from an image of a diagnosis target is compared and a difference (abnormality) in the image of the diagnosis target can be extracted. The reference image may be generated from an image that the image capturing units (331 and 332) capture this printed matter having been normally printed. Note that the operation of the image capturing units (331 and 332) is an example of "capturing". In S609, the CPU 214 executes processing for causing the image capturing units (331 and 332) to capture the printed matter having been printed. Then, the CPU 214 saves the captured image as a diagnostic image into the HDD unit 216 of the diagnosis unit 108, and proceeds to S610.

In S610, the CPU 214 compares the reference image with the diagnostic image, and generates difference image data for determining an abnormality in the printing unit 107. In S611, the CPU 214 derives an area of the difference from the difference image data of S610, and determines whether or not this difference area is larger than the size K of abnormality detection in inspection. When determining that the difference area is larger than the size K, the CPU 214 determines that the inspection result is unacceptable, and proceeds to S612. On the other hand, when determining that the difference area is the size K or less, the CPU 214 proceeds to S614.

In S612, the CPU 214 displays a job management screen indicating that the inspection result is unacceptable on the UI display unit 241. In S613, the stacker 109 discharges, to the escape tray 346, the printed matter unacceptable in inspection having been conveyed on the conveyance path. Note that the stacker 109 discharges, to the stack tray 341, the printed matter not unacceptable in inspection, or conveys it to the finisher 110 connected downstream in the conveyance direction of the printed matter having been printed. The stacker 109 discharges only the printed matter unacceptable in inspection to the escape tray 346, whereby it is possible to distinguish between an item unacceptable in inspection and a normal item OK in inspection.

In S614, the CPU 214 determines whether the setting of the precursor diagnosis is "implement" or "do not implement". When determining that the setting of the precursor diagnosis is "implement", the CPU 214 proceeds to S615, and when determining that it is "do not implement", proceeds to S618. In S615, the CPU 214 determines whether or not the difference area derived from the difference image data generated in S610 is larger than the detection size Z of the abnormality in the precursor diagnosis. When determining that the difference area is larger than the size Z, the CPU 214 proceeds to S616. On the other hand, when determining that the difference area is the size Z or less, the CPU 214 proceeds to S618.

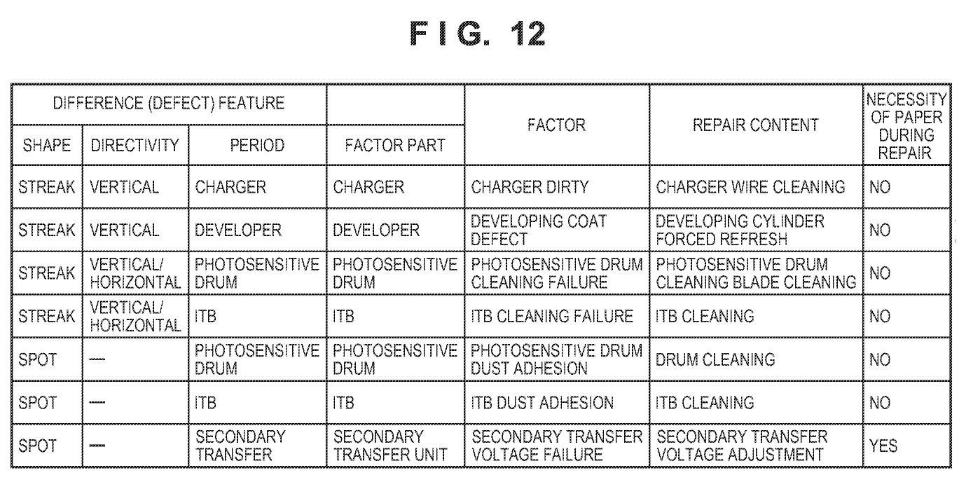

In S616, the CPU 214 specifies a part to be a factor in the precursor of the difference (abnormality) based on feature information of the difference area. More specifically, the CPU 214 selects a combination having an identical color and high similarity in the difference area, and specifies the part of the factor in the difference and the cause of the difference from period information of the selected combination. Note that the feature of the difference area may be, for example, a shape, directivity, or the like other than the period. Note that the shape is, for example, a linear shape (hereinafter, also called a streak) and a dotted shape (hereinafter, also called a spot). The directivity is a vertical direction and a horizontal direction. The period is, for example, an interval of the abnormality formed on the printed matter in a charger, a developer, a photosensitive drum, an ITB unit, and secondary transfer. FIG. 12 shows a problem part and a difference cause of such a difference (abnormality), and a relationship between repair content for repairing this difference and necessity of paper in a case of repairing. Data as shown in FIG. 12 is saved in advance in the memory 215. Then, with reference to this relational data, the CPU 214 specifies the part of the factor in the difference and the factor in the difference corresponding to the feature of the difference, the content of the repair, and the necessity of paper in the case of repairing.

In S617, the CPU 214 saves the part specified in S616 and the repair content in the HDD unit 216. In S618, the CPU 206 determines whether or not printing has ended for all the pages given a print command in the print job. Then, when determining that printing has all ended, the CPU 206 proceeds to S619, and otherwise, returns to S606. In S619, the CPU 214 determines whether or not the repair content is stored in the HDD unit 216. Then, when determining that the repair content is stored, the CPU 214 determines whether or not the repair is actually necessary. Then, when determining that repair is necessary, the CPU 214 proceeds to S620, and otherwise, ends the processing of the flowchart. In S620, the CPU 214 notifies the printing unit 107 of the repair content via the communication I/F 211. Note that the operation of the CPU 214 in S620 is an example of "outputting". Then, in the printing unit 107, the CPU 206 receives this repair content via the communication I/F 201 and performs control to execute the repair content. Then, the flowchart is ended.

### Relationship Between Inspection Diagnosis Level and Detection Size

The relationship among the inspection diagnosis level, the detection size K of the abnormality in the inspection, and the detection size Z of the abnormality in the precursor diagnosis will be described with reference to FIG. 7. The size K and the size Z are changed according to the setting of each of "strict", "normal", and "lenient" of the inspection diagnosis level. Note that the example illustrated in FIG. 7 is a case where the shape of the abnormality is a spot, and the detection size is defined by the area (an example of "size"), but for example, the shape of the abnormality may be a streak, and the detection size may be defined by the length, the thickness, or the like (an example of "size"). Note that the size K = 0.5 mm² when the inspection diagnosis level is "strict" is a detection limit of the image forming apparatus 101.

The spot illustrated in FIG. 7 is an abnormality when toner particles are initially attached to a drum, a transfer belt, or the like, and the spot grows in a dotted shape with the attached toner as a core. Therefore, the detection size Z is set to be smaller than the detection size K in order to detect the precursor of this growth into the spot. When the precursor diagnosis is set to "implement", the size Z is set to a value not exceeding the detection limit of the diagnosis unit 108. On the other hand, when the precursor diagnosis is set to "do not implement", the size Z is set to a value exceeding the detection limit of the diagnosis unit 108.

That is, in the example of FIG. 5, the inspection diagnosis level is set to "normal", and the precursor diagnosis is set to "implement". In such a case, the size Z is set to a value (e.g., 0.5 mm²) smaller than the size K and not exceeding the detection limit of the diagnosis unit 108. On the other hand, in the example of FIG. 8, the inspection diagnosis level is set to "strict", and the precursor diagnosis is set to "do not implement". In such a case, the size Z is set to a value (e.g., 0.2 mm²) smaller than the size K and exceeding the detection limit of the diagnosis unit 108. Note that 0.2 mm² is an example of a "reference by which the second abnormality cannot be detected". When the size Z is set to 0.2 mm², since the detection limit of the image forming apparatus 101 is 0.5 mm², a spot less than 0.5 mm² cannot be actually detected. However, even in such a case, a program such as data analysis for precursor diagnosis is unnecessarily executed. Therefore, according to the print system 100 according to the first embodiment, in such a case, the precursor diagnosis is set to "do not implement" as in S603 described above, and wasteful execution of the precursor diagnosis is prevented.

### Repair Content

A factor part and a difference cause corresponding to the feature of the difference (abnormality), and a relationship between repair content for repairing this difference and necessity of paper in a case of repairing will be described with reference to FIG. 12. The CPU 214 of the diagnosis unit 108 detects the shape of the difference, the directivity of the shape, and the period of the difference from the difference image. Then, with reference to such table information, the CPU 214 specifies the factor part and the cause of the difference corresponding to the difference image.

More specifically, the CPU 214 detects that, for example, a streak occurs in a lateral direction in the difference image and the period thereof depends on the photosensitive drum. Such detection may be implemented by using, for example, a known image processing technique or an independently developed algorithm. Note that the streak is a linear abnormality attached to, for example, a drum, a belt, and the like. Then, with reference to the table shown in FIG. 12, the CPU 214 specifies that the factor part is the photosensitive drum, and the cause is a cleaning failure of the photosensitive drum. The CPU 214 determines cleaning of a cleaning blade of the photosensitive drum (an example of "removal of a cause of the second abnormality") as the repair content. Then, the printing unit 107 implements cleaning of the cleaning blade of the photosensitive drum as described above. In this manner, repair of the cleaning blade of the photosensitive drum is executed.

Alternatively, the CPU 214 detects that, for example, a spot occurs in the difference image, and the period thereof depends on the photosensitive drum. Then, with reference to the table shown in FIG. 12, the CPU 214 specifies that the factor part is the photosensitive drum and the cause is adhesion of dust to the photosensitive drum. Then, the CPU 214 determines cleaning of the photosensitive drum as the repair content. Then, as described above, the printing unit 107 implements cleaning of the photosensitive drum. In this manner, repair of the photosensitive drum is executed.

In this manner, the cause of the abnormality is specified from the shape, directivity, period, or the like of the difference (abnormality) appearing in the difference image, and the repair content suitable for the cause is selected, and repair is implemented. Note that the content of the table in FIG. 12 is part of the repair content, and the repair content is not limited to this.

### Actions and Effects

According to the print system 100 as described above, the precursor diagnosis is not performed when the inspection diagnosis level is set to "strict". According to such the print system 100, it is possible to prevent the precursor diagnosis from being wasted by implementing the precursor diagnosis when the detection size Z in the precursor diagnosis is set to a value exceeding the detection limit of the image forming apparatus 101. By not executing the precursor diagnosis, it is possible to suppress repair work and cleaning work for which an urgent response is unnecessary. Hence, it is possible to suppress an opportunity loss of the user due to stopping of the operation of the image forming apparatus 101 and to prevent a decrease in productivity of the user.

### Second Embodiment

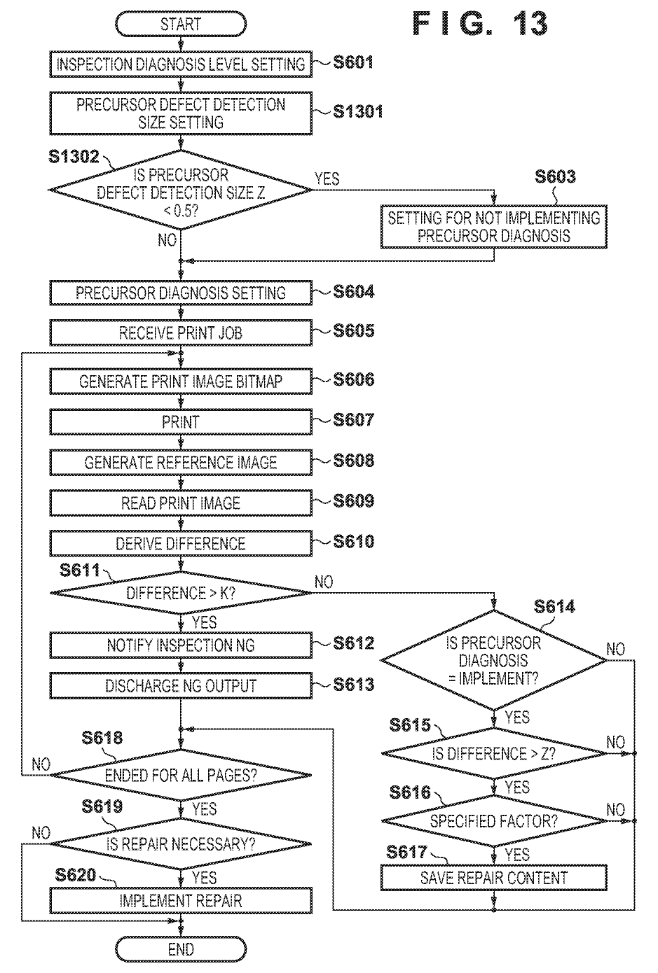

In the first embodiment, an example in which the precursor diagnosis is not implemented even if the detection size Z of the abnormality in the precursor diagnosis is set when the inspection diagnosis level 501 is set to "strict" has been described. In the second embodiment, an example in which the precursor diagnosis is not implemented according to the detection size Z of the abnormality in the precursor diagnosis will be described with reference to FIGS. 13 and 14. Note that the processings common to those in FIG. 6 are denoted by the same reference numerals, and description thereof will be omitted.

The precursor diagnosis level will be described with reference to FIG. 14. The precursor diagnosis level is set from, for example, three of "early detection", "standard detection", and "late detection". "Early detection" is set in a case where it is desired to find an abnormality early although the frequency of repairing increases, for example. On the other hand, "late detection" is set in a case where it is desired to reduce the frequency of repairing, for example. Note that the setting of the precursor diagnosis level may be executed by a service engineer (not illustrated).

FIG. 14 illustrates the detection size Z in a case where the precursor diagnosis level is "early detection". In the first embodiment, as illustrated in FIG. 7, when the setting of the diagnosis level in inspection is "lenient", the detection size Z is set to 1.0 mm². However, in the second embodiment, when the precursor diagnosis level is "early detection" and the diagnosis level in inspection is set to "lenient", the detection size Z is set to 0.5 mm². Similarly, the size Z is set to 0.2 mm² when the diagnosis level in inspection is "normal", and is set to 0.1 mm² when the diagnosis level is "strict".

In the second embodiment, also when the setting of the diagnosis level in inspection is not "strict" but "normal", the detection size Z is set to 0.2, which falls below the limit size of detection by the diagnosis unit 108. In such a case, when the processing of FIG. 6 according to the first embodiment is executed, the precursor diagnosis may be executed even though the precursor of the abnormality cannot be detected. Therefore, in the second embodiment, as illustrated in FIG. 16, a message that the precursor diagnosis may be impossible is displayed on the diagnosis screen. Note that such a case is an example of "display, on the screen, a message indicating a possibility of not diagnosing the second abnormality when the first setting is a setting other than a strictest reference of a plurality of references".

### Inspection Diagnosis Processing and Precursor Diagnosis Processing

A procedure of the inspection diagnosis processing and the precursor diagnosis processing according to the second embodiment will be described with reference to FIG. 13. Note that the processing in FIG. 13 is implemented, for example, by the CPU 206 of the printing unit 107 and the CPU 214 of the diagnosis unit 108 of the image forming apparatus 101 reading and executing programs stored in the memory 207 and the memory 215. The processing in FIG. 13 is implemented, for example, by the CPU 251 of the external controller 102 reading and executing a program stored in the memory 252. The processing in FIG. 13 is implemented, for example, by the CPU 251 of the client PC 103 reading and executing a program stored in the memory 252. Note that before the start of the processing in FIG. 13, the setting of the precursor diagnosis is set to "implement".

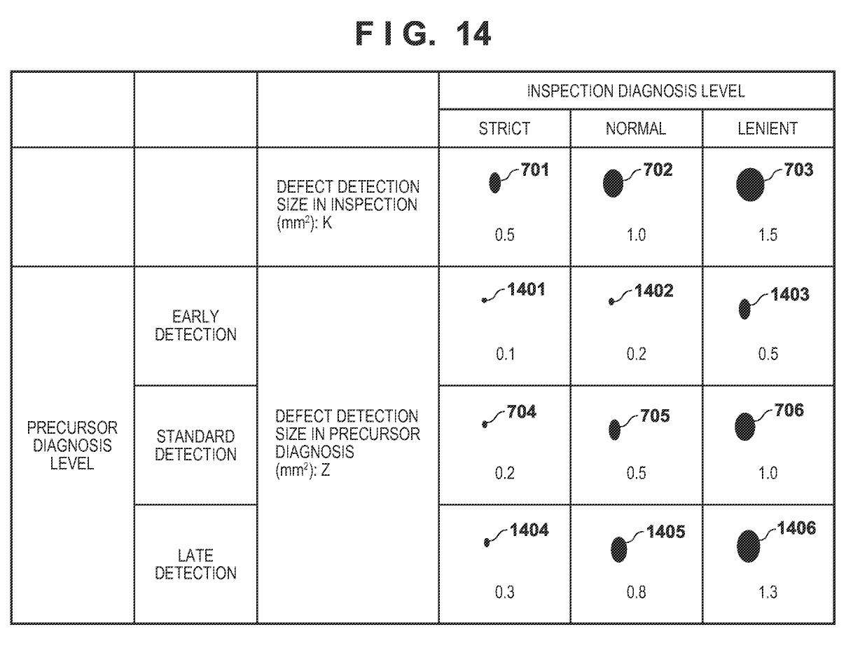

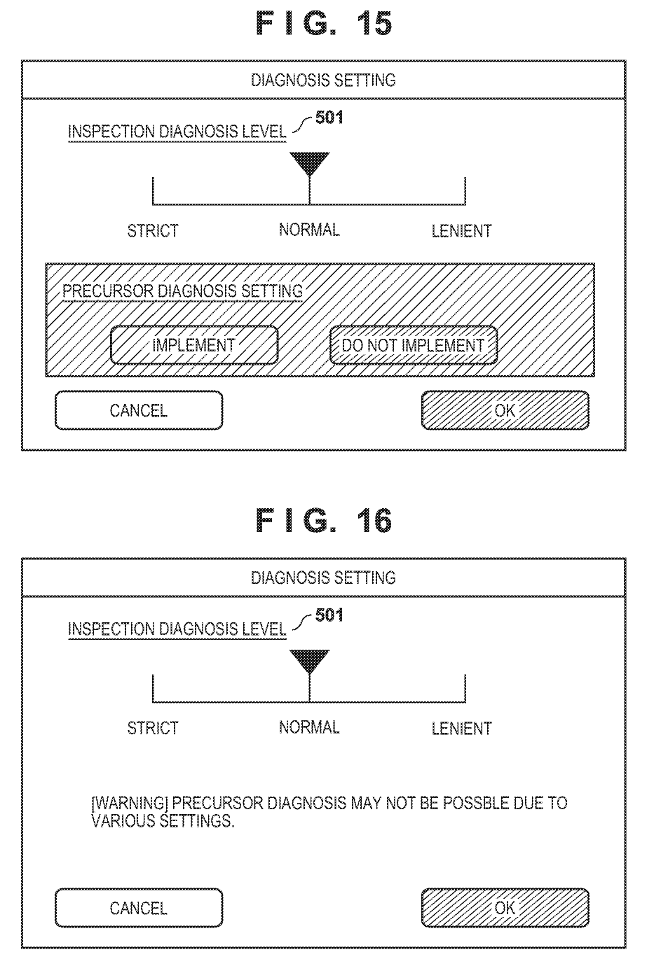

In S601, the CPU 214 of the diagnosis unit 108 displays the diagnosis setting screen illustrated in FIG. 5 of the user mode on the UI display unit 241. Then, the CPU 214 receives a setting input of the inspection diagnosis level 501 via the operation unit 242. Then, the CPU 214 sets a detection size K of an abnormality in the inspection as illustrated in FIG. 14 according to the setting of the inspection diagnosis level, and performs setting as to what size of the abnormality to detect. For example, as illustrated in FIG. 15, when the inspection diagnosis level is set to "normal", the detection size K of the abnormality in inspection is set to 1.0 mm².

In S1301, the CPU 214 sets the detection size Z in the precursor diagnosis according to the setting of the inspection diagnosis level, and performs setting as to what size of the precursor to detect. That is, in the example of the setting screen illustrated in FIG. 15, the arrow indicating the inspection diagnosis level 501 is positioned at "normal". Hence, the CPU 214 sets the detection size Z of the abnormality in the precursor diagnosis to 0.2 mm² at which early precursor detection is possible, for example (FIG. 14).

In S1302, the CPU 214 determines whether or not the detection size Z is less than 0.5 mm², which is the limit size detectable by the diagnosis unit 108. When the detection size Z is 0.5 mm², the CPU 214 proceeds to S603, and otherwise, proceeds to S604. In S603, the CPU 214 sets the precursor diagnosis to "do not implement", and changes the color of the icon of "do not implement" of the setting of the precursor diagnosis as illustrated in FIG. 15. The area for the precursor diagnosis setting is grayed out. By doing this, it is displayed that the setting of the precursor diagnosis cannot be selected. Even in a case where the diagnosis level is set to "normal" in this manner, the precursor diagnosis is not performed when the detection size of the abnormality in the precursor diagnosis is less than 0.5 mm².

### Actions and Effects

The image forming apparatus 101 according to the second embodiment also achieves effects similar to those of the image forming apparatus 101 according to the first embodiment. In addition, according to the image forming apparatus 101 according to the second embodiment, it is possible to determine whether or not to implement the precursor diagnosis even if the setting of the diagnosis level in inspection is other than "strict". Hence, the precursor diagnosis can be executed more efficiently.

### Third Embodiment

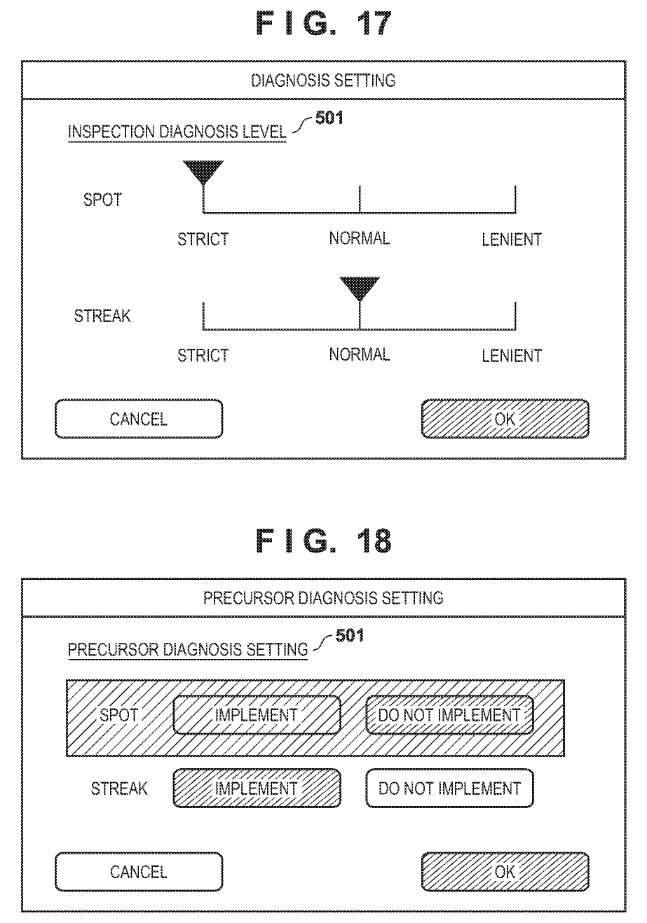

In the third embodiment, on the diagnosis setting screen, the inspection diagnosis level and the presence or absence of execution of the precursor diagnosis are set according to the shape of the abnormality (spot, streak, and the like). More specifically, on the diagnosis setting screen as illustrated in FIG. 17, the inspection diagnosis level 501 is displayed in a settable manner in each of a case where the shape is a spot and a case where the shape is a streak. On the setting screen of the precursor diagnosis as illustrated in FIG. 18, the precursor diagnosis setting 502 is displayed in a settable manner for each of a spot and a streak.

The diagnosis setting screen in FIG. 17 illustrates that the arrow indicating the inspection diagnosis level of the spot is positioned at "strict" and the arrow indicating the inspection diagnosis level of the streak is positioned at "normal". In such a case, the CPU 214 changes the color of the icon of "do not implement" of the setting of the precursor diagnosis of the spot in which the setting of the diagnosis level in inspection is set to "strict" on the setting screen of the precursor diagnosis in FIG. 18. The CPU 214 grays out the entire setting area of the spot in order to indicate that this setting cannot be changed. On the other hand, the CPU 214 changes the color of the icon of "implement" of the setting of the precursor diagnosis of the streak in which the setting of the diagnosis level in inspection is "normal".

### Actions and Effects

The image forming apparatus 101 according to the third embodiment also achieves effects similar to those of the image forming apparatus 101 according to the first embodiment. In addition, according to the image forming apparatus 101 according to the third embodiment, implementation of the precursor diagnosis can be set according to the shape of the abnormality. Hence, the precursor diagnosis can be executed more efficiently.

### Variation Example

When the precursor diagnosis setting 502 is set to "implement" on the diagnosis setting screen in FIG. 5, the CPU 214 may display "strict" of the inspection diagnosis level 501 such that it cannot be selected. Note that such display is an example of "display a first setting in which the first reference is a strictest reference of a plurality of references when the second setting is set to diagnose the second abnormality such that the first setting cannot be selected".

When the precursor diagnosis is set not to be implemented in S603, the determination processing from S614 to S616 may be omitted. In S608, the image forming apparatus 101 may receive, via the external LAN 104 and the internal LAN 105, the reference image generated outside the image forming apparatus 101. In S609, the CPU 214 may receive, via the external LAN 104 and the internal LAN 105, the diagnostic image captured outside the image forming apparatus 101. In S617, the CPU 206 may transmit, via the external LAN 104 and the internal LAN 105, the specified part and the repair content to the client PC 103. Then, the client PC 103 may transmit a repair instruction including this repair content to another image forming apparatus 101 via the network.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-150230, filed August 30, 2024, which is hereby incorporated by reference herein in its entirety.

What is claimed is:

1. An image forming apparatus comprising:
one or more memory devices that store a set of instructions; and
one or more processors that execute the set of instructions to:
diagnose, based on a first reference, a first abnormality in an image formed on a sheet, and diagnose a second abnormality based on a second reference stricter than the first reference; and
set whether or not to execute diagnosis of the second abnormality, wherein
the second abnormality is set not to be diagnosed when the second reference is a reference by which the second abnormality cannot be detected by diagnosis.

2. The image forming apparatus according to claim 1, wherein
the one or more processors further execute instructions in the one or more memory devices to:
set the second abnormality not to be diagnosed when the first reference is a reference that is same as a limit at which the first abnormality can be detected by diagnosis or by which the first abnormality cannot be detected by diagnosis, or when the second reference is a reference by which the second abnormality cannot be detected by diagnosis.

3. The image forming apparatus according to claim 1, wherein
the one or more processors further execute instructions in the one or more memory devices to:
set the second abnormality not to be diagnosed when the first reference is set to a strictest reference among the plurality of references.

4. The image forming apparatus according to claim 1, wherein
the one or more processors further execute instructions in the one or more memory devices to:
set the second abnormality not to be diagnosed when the second reference is set to a size that cannot be detected by diagnosis.

5. The image forming apparatus according to claim 3, wherein the second reference can be set stepwise for each of a plurality of the first references.

6. The image forming apparatus according to claim 1, wherein
the first reference can be set for each type of the first abnormality.

7. The image forming apparatus according to claim 1, wherein
the one or more processors further execute instructions in the one or more memory devices to:
capture the image formed on the sheet; and
by using a difference between an original image of the image before being formed on the sheet and the image having been captured, diagnose whether or not the first abnormality and the second abnormality are present in the image having been captured.

8. The image forming apparatus according to claim 1, wherein
the one or more processors further execute instructions in the one or more memory devices to:
output content for implementing removal of a cause of the second abnormality when the second abnormality is diagnosed to be present.

9. The image forming apparatus according to claim 1, wherein
the one or more processors further execute instructions in the one or more memory devices to:
selectively display, on a screen, a first setting to set the first reference and a second setting to set existence or absence of execution of diagnosis of the second abnormality.

10. The image forming apparatus according to claim 9, wherein
the one or more processors further execute instructions in the one or more memory devices to:
identifiably display not diagnosing the second abnormality when the second setting is a setting not to diagnose the second abnormality; and
display the second setting such that the second setting cannot be selected.

11. The image forming apparatus according to claim 9, wherein
the one or more processors further execute instructions in the one or more memory devices to:
display, on the screen, that the second setting is a setting not to diagnose the second abnormality when the first setting is a setting other than a strictest reference of a plurality of references.

12. The image forming apparatus according to claim 9, wherein
the one or more processors further execute instructions in the one or more memory devices to:
display, on the screen, a message indicating a possibility of not diagnosing the second abnormality when the first setting is a setting other than a strictest reference of a plurality of references.

13. The image forming apparatus according to claim 9, wherein
the one or more processors further execute instructions in the one or more memory devices to:
display a first setting in which the first reference is a strictest reference of a plurality of references such that the first setting cannot be selected when the second setting is set to diagnose the second abnormality.

14. The image forming apparatus according to claim 9, wherein
the one or more processors further execute instructions in the one or more memory devices to:
display, on the screen, a message indicating that diagnosis of the second abnormality cannot be performed when the first reference is set to a strictest reference of a plurality of references.

15. The image forming apparatus according to claim 9, wherein
the one or more processors further execute instructions in the one or more memory devices to:
display the first setting and the second setting on one screen.

16. The image forming apparatus according to claim 9, wherein
the one or more processors further execute instructions in the one or more memory devices to:
display the first setting and the second setting on individual screens.

17. A control method of an image forming apparatus, the control method comprising:
diagnosing, based on a first reference, a first abnormality in an image formed on a sheet, and diagnosing a second abnormality based on a second reference stricter than the first reference; and
setting whether or not to execute diagnosis of the second abnormality, wherein
the second abnormality is set not to be diagnosed when the second reference is a reference by which the second abnormality cannot be detected by diagnosis.

18. A non-transitory computer-readable storage medium storing a computer program for causing a computer to execute each process in a control method of an image forming apparatus, the control method comprising:
diagnosing, based on a first reference, a first abnormality in an image formed on a sheet, and diagnosing a second abnormality based on a second reference stricter than the first reference; and
setting whether or not to execute diagnosis of the second abnormality, wherein
the second abnormality is set not to be diagnosed when the second reference is a reference by which the second abnormality cannot be detected by diagnosis.
